(19) United States
(12) Patent Application Publication
(10) Pub. No.: US 2022/0215470 A1
(43) Pub. Date: Jul. 7, 2022

(54) System and Method for Pushing Recommended Financial Transactions to a Mobile Device or Computer

(71) Applicant: Steven Woods, New York City, NY (US)

(72) Inventor: Steven Woods, New York City, NY (US)

(73) Assignee: Stirlingshire Investments, Inc., New York, NY (US)

(21) Appl. No.: 17/141,160

(22) Filed: Jan. 4, 2021

(51) Int. Cl. G06Q 40/04; G06Q 40/06; G06F 16/955; H04L 12/58

(52) U.S. Cl. CPC G06Q 40/04; H04L 51/08; G06F 16/955; G06Q 40/06

(57) ABSTRACT

A system and method for pushing recommended trades to a mobile device is disclosed. The system commutatively couples a broker computer to a client mobile device over the Internet. The broker computer includes a broker application controller; a non-transitory memory storing a program; and a web interface configured to establish communication connections with the one or more client devices over the Internet. The broker application controller is configured to execute instructions stored within the non-transitory causing the broker application controller to create a recommendation order for submission to a client for approval, populate the recommendation with data values to define a transaction being recommended, attach due diligence research information to the recommended order for providing relevant information to the client, securely transmit the recommended order to a client mobile application running on the client mobile device, securely receive a responsive client responsive message from the client mobile application running on the client mobile device providing an acceptance of the recommended order, execute the completed order, and transmit confirmation of an executed transaction based upon the completed order to the client mobile application running on the client mobile device. The responsive message contains a completed order for a transaction.

### TECHNICAL FIELD

This application relates in general to a system and method for providing financial services, and more specifically, to a system and method for pushing recommended Transactions in Stocks, Options, Bonds, Mutual Funds, ETF's, Futures, and other Derivatives to a mobile device or computer while simultaneously logging and sharing of due diligence the broker or advisor has created of preformed before making the recommendation to the client to fulfill the SEC Reg BI requirement.

### BACKGROUND

Traditionally, a broker or financial advisor who works in a full-service capacity, one who makes recommendations as to what assets a customer should buy or sell, will speak with a client over the phone to discuss what buys and sells he/she recommends. This sequence of events can cause several problems, the first is simply unauthorized trading. Unauthorized trading is where a broker or advisor who does not have authorization for trading discretion does not actually speak with a client before executing a trade in the client's account. This type of trading happens far more frequently than many like to admit and can be very detrimental to the client. Often this is done by an advisor simply to charge a commission.

Additionally, brokers or financial advisors owe a duty to the client to provide a sound basis for any recommendations. These same brokers and financial advisors may be challenged by clients, brokerages, and government regulators to justify any due diligence performed before any recommendation is made. These challenges typically arise when a recommendation does not provide the financial results that are expected. Documenting what information was used as a basis for the recommendation and that the information was, in fact, provided to a client before a trade is made can be difficult well after the trade has occurred.

Therefore, a need exists for a system and method for pushing recommended trades to a mobile device. The present invention attempts to address the limitations and deficiencies in existing systems according to the principles and example embodiments disclosed herein.

### SUMMARY

In accordance with the present invention, the above and other problems are solved by providing a system and method for pushing recommended trades to a mobile device according to the principles and example embodiments disclosed herein.

In one embodiment, the present invention is a system for pushing recommended trades to a mobile device. The system commutatively couples a broker computer to a client mobile device over the Internet. The broker computer includes a broker application controller; a non-transitory memory storing a program; and a web interface configured to establish communication connections with the one or more client devices over the Internet. The broker application controller is configured to execute instructions stored within the non-transitory causing the broker application controller to create a recommendation order for submission to a client for approval, populate the recommendation with data values to define a transaction being recommended, attach due diligence research information to the recommended order for providing relevant information to the client, securely transmit the recommended order to a client mobile application running on the client mobile device, securely receive a responsive client responsive message from the client mobile application running on the client mobile device providing an acceptance of the recommended order, execute the completed order, and transmit confirmation of an executed transaction based upon the completed order to the client mobile application running on the client mobile device. The responsive message contains a completed order for a transaction.

In another embodiment, the present invention is a method for pushing recommended trades to a mobile device. The method creates a recommendation order for submission to a client for approval, populates the recommendation with data values to define a transaction being recommended, attach due diligence research information to the recommended order for providing relevant information to the client, securely transmits the recommended order to a client mobile application running on the client mobile device, securely receives a responsive client responsive message from the client mobile application running on the client mobile device providing an acceptance of the recommended order, executing the completed order, and transmits confirmation of an executed transaction based upon the completed order to the client mobile application running on the client mobile device. The responsive message contains a completed order for a transaction.

An aspect of the present disclosure provides a non-transitory computer-readable recording medium in a broker computer for pushing recommended trades to a mobile device, the non-transitory computer-readable recording medium storing one or more programs which when executed by a network controller of the gateway device performs steps of the methods described above

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates a system for pushing recommended trades to a mobile device according to the present invention.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIG. 3 illustrates example embodiments of web pages and application screens for a system and method for pushing recommended trades to a mobile device according to the present invention.

FIG. 4 illustrates a computing system of software components for a system of pushing recommended trades to a mobile device according to the present invention.

FIG. 5 illustrates a flowchart corresponding to a method performed by software components of a system for pushing recommended trades to a mobile device according to the present invention.

### DETAILED DESCRIPTION

This application relates in general to a system and method for providing financial services, and more specifically, to a system and method for pushing recommended trades to a mobile device according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The term “mobile application” refers to an application executing on a mobile device such as a smartphone, tablet, and/or web browser on any computing device.

The terms “individual” and “user” refer to an entity, e.g. a human, using a system for pushing recommended trades to a mobile device including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), and ethernet cable(s) or wireless connection(s) using any type of frequency/frequencies or radio wave(s). Some examples are including below in this application.

The term “invention” or “present invention” refers to the invention being applied for via the patent application with the title “System and Method for Pushing Recommended Trades to a Mobile Device.” Invention may be used interchangeably with mobile application.

The terms “communicate,” or “communication” refer to any component(s) connecting with any other component(s) in any combination for the purpose of the connected components to communicate and/or transfer data to and from any components and/or control any settings.

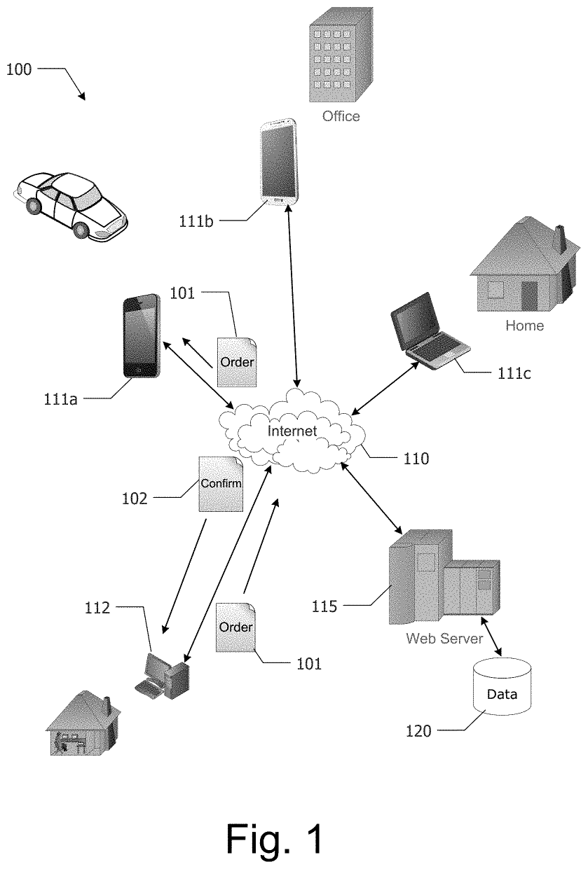

In general, the present disclosure relates to a system and method for pushing recommended trades to a mobile device. To better understand the present invention, FIG. 1 illustrates a system for pushing recommended trades to a mobile device according to the present invention. A broker or financial advisor, using a computing system 112, pushes to either a mobile device or computer 111a-c controlled by the client a fully prepopulated trade 101 that has been agreed upon before-hand for the client to confirm what was discussed during their verbal conversation. When the client confirms 102 the trade by selecting the confirm button on a mobile application screen 300 it then executes the trade. This method removes all possibility of unauthorized trades taking place in the client's account as all details of the trade that have been discussed have been presented to the client for execution and it is the client that actually triggers the trade.

When the recommended order 101 is sent from the broker's computer 112 to one or more of the client's devices 111a-c, the order 101 is typically sent via a web server 115. The web server 115 may act as a simple relay device to forward the order 101 on to the one or more of the client's devices 111a-c. The web server 115 also may store the order 101 on storage devices 120 for later retrieval. The web server 115 also may be used to retain copies of these orders 101 and corresponding confirmation 102 for later use in documenting the transaction.

The order 101 contains personal and sensitive information that is meant only for the client. As such, the order 101 is typically encrypted using an encryption key only known by the client and/or the mobile application 401. When the order 101 is sent directly to the one or more of the client's devices 111a-c, the client's mobile devices will decrypt the order for presentation and action by the client. The mobile application 401 may require a client to enter a password or other data known only to the client to ensure that the order is not viewed by anyone other than the client. Other methods of authentication including two-factor login and biometric feature matching also may be used by the mobile application 401 to authenticate that an authorized user is viewing the order 101. When the client responds with a confirmation 102 of the order, the confirmation 102 is encrypted by the mobile application 401 before the confirmation is sent over the Internet 110 to the broker's computer 112.

If the web server 115 stored the order 101 for later retrieval by the client, the one or more of the client's devices 111a-c may be required to establish a secure connection to the web server 115, to perform authentication using passwords, two factor logins, and/or biometric feature matching performed between the mobile application 301 and the web server 115 before the order 101 is provided to the one or more of the client's devices 111a-c. As above, any confirmation 102 that is sent by the client to the web server 115 for later retrieval by the broker may be encrypted for added security.

The invention may use any type of network such as a single network, multiple networks of a same type, or multiple networks of different types which may include one or more of a direct connection between devices, including but not limited to a local area network (LAN), a wide area network (WAN) (for example, the Internet), a metropolitan area network (MAN), a wireless network (for example, a general packet radio service (GPRS) network), a long term evolution (LTE) network, a telephone network (for example, a Public Switched Telephone Network or a cellular network), a subset of the Internet, an ad hoc network, a fiber optic network (for example, a fiber optic service (often known as FiOS) network), or any combination of the above networks.

Smart devices mentioned herein the present application may also use one or more sensors to receive or send signals, such as wireless signals for example, Bluetooth™, wireless fidelity, infrared, Wi-Fi, or LTE. Any smart device mentioned in this application may be connected to any other component or smart device via wired communications (e.g., conductive wire, coaxial cable, fiber optic cable, ethernet cable, twisted pair cable, transmission line, waveguide, etc.), or a combination of wired and wireless communications. The invention's method and/or system may use a single server device or a collection of multiple server devices and/or computer systems.

The systems and methods described above, may be implemented in many different forms of applications, software, firmware, and hardware. The actual software or smart device application codes or specialized control software, hardware or smart device application(s) used to implement the invention's systems and methods is not limiting of the implementation. Thus, the operation and behavior of the systems and methods were described without reference to the specific software or firmware code. Software, smart device application(s), firmware, and control hardware can be designed to implement the systems and methods based on the description herein.

While all of the above functions are described to be provided to users via a mobile application on a smartphone 111b, one of ordinary skill will recognize that any computing device including tablets 111a, laptops 111c, and general-purpose computing devices may be used as well. In at least one embodiment, all of the services described herein are provided using web pages being accessed from the web server 115 using a web browser such as Safari™, Firefox™, Chrome™, DuckDuckGo™, and the like. All of the screen examples described herein show user interface elements that provide the functionality of the present invention. The arrangement, organization, presentation, and use of particular user input/output (I/O) elements including hyperlinks, buttons, text fields, scrolling lists, and similar I/O elements are shown herein for example embodiments only to more easily convey the features of the present invention. The scope of the present invention should not be interpreted as being limited by any of these elements unless expressly recited within the attached claims.

For the purposes of the example embodiment of FIG. 1, various functions are shown to be performed on different programmable computing devices that communicate with each other over the Internet 110. These computing devices may include smartphones 111b, laptop computers 111c, tablets 111a, and similar devices so long as the disclosed functionality of the mobile application described herein is supported by the particular computing device. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present invention. The attached claims recite any required combination of functionality onto a single machine, if required, and all example embodiments are for descriptive purposes.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects, and in order to more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method or algorithm is carried out or executed. Some steps may be omitted in some aspect or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC) or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example, an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines or other appropriate virtual environments).

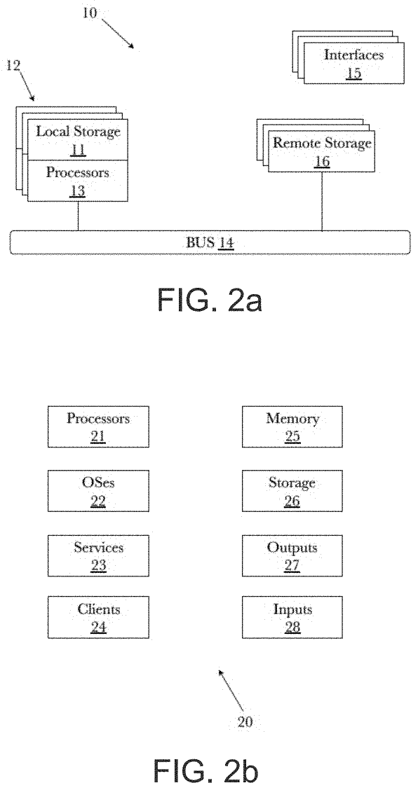

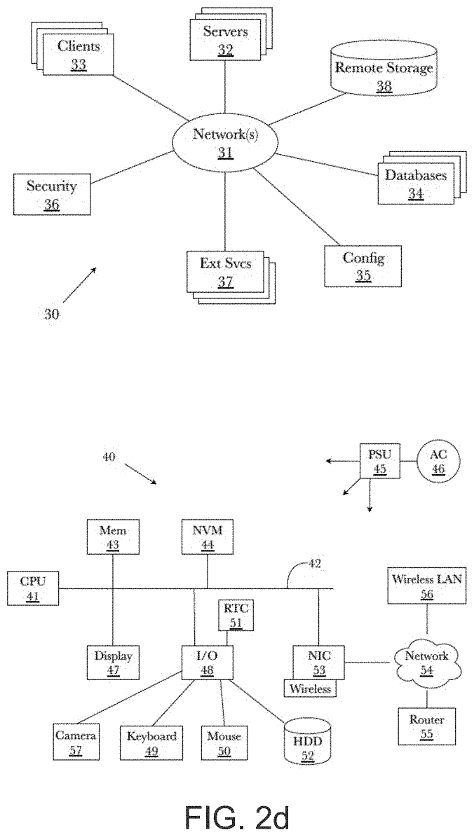

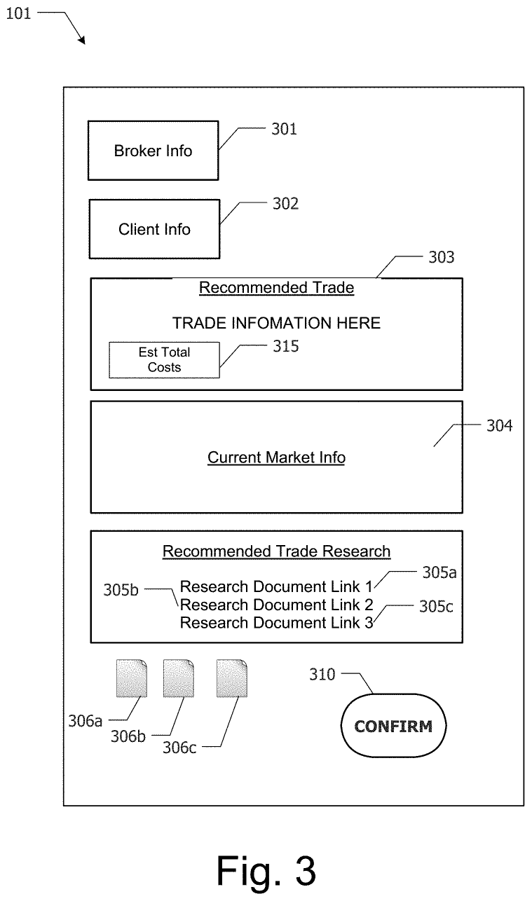

Referring now to FIG. 2a, there is a block diagram depicting an exemplary computing device 10 suitable for implementing at least a portion of the features or functionalities disclosed herein. The computing device 10 may be, for example, any one of the computing machines listed in the previous paragraph, or indeed any other electronic device capable of executing software- or hardware-based instructions according to one or more programs stored in memory. The computing device 10 may be configured to communicate with a plurality of other computing devices, such as clients or servers, over communications networks, such as a wide area network, a metropolitan area network, a local area network, a wireless network, the Internet or any other network, using known protocols for such communication, whether wireless or wired.

In one aspect, the computing device 10 includes one or more central processing units (CPU) 12, one or more interfaces 15, and one or more buses 14 (such as a peripheral component interconnect (PCI) bus). When acting under the control of appropriate software or firmware, the CPU 12 may be responsible for implementing specific functions associated with the functions of a specifically configured computing device or machine. For example, in at least one aspect, a computing device 10 may be configured or designed to function as a server system utilizing a CPU 12, local memory 11 and/or remote memory 16, and interface(s) 15. In at least one aspect, a CPU 12 may be caused to perform one or more of the different types of functions and/or operations under the control of software modules or components, which for example, may include an operating system and any appropriate applications software, drivers, and the like.

A CPU 12 may include one or more processors 13 such as for example, a processor from one of the Intel, ARM, Qualcomm, and AMD families of microprocessors. In some aspect, processors 13 may include specially designed hardware such as application-specific integrated circuits (ASICs), electrically erasable programmable read-only memories (EEPROMs), field-programmable gate arrays (FPGAs), and so forth, for controlling operations of a computing device 10. In a particular aspect, a local memory 11 (such as non-volatile random access memory (RAM) and/or read-only memory (ROM), including for example, one or more levels of cached memory) also may form part of a CPU 12. However, there are many different ways in which memory may be coupled to a system 10. Memory 11 may be used for a variety of purposes such as, for example, caching and/or storing data, programming instructions, and the like. It should be further appreciated that a CPU 12 may be one of a variety of system-on-a-chip-(SOC)-type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may, for example, support other peripherals used with a computing device 10. Among the interfaces that may be provided are ethernet interfaces, frame relay interfaces, cable interfaces, DSL interfaces, token ring interfaces, graphics interfaces, and the like. In addition, various types of interfaces may be provided such as, for example, universal serial bus (USB), serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast ethernet interfaces, gigabit ethernet interfaces, serial ATA (SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interfaces (HSSI), point of sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and a server system (such as a server system described in more detail below).

Regardless of network device configuration, the system of an aspect may employ one or more memories or memory modules (for example, remote memory block 16 and local memory 11) configured to store data, program instructions for the general-purpose network operations or other information relating to the functionality of the aspects described herein (or any combinations of the above). Program instructions may control execution of or comprise an operating system and/or one or more applications, for example. Memory 16 or memories 11, 16 also may be configured to store data structures, configuration data, encryption data, historical system operations information or any other specific or generic non-program information described herein.

Because such information and program instructions may be employed to implement one or more systems or methods described herein, at least some network device aspects may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device) or they may be removable such as swappable flash memory modules (such as “thumb drives” or other removable media designed for rapidly exchanging physical storage devices), “hot-swappable” hard disk drives or solid state drives, removable optical storage disks, or other such removable media, and that such integral and removable storage media may be utilized interchangeably. Examples of program instructions include both object code, such as may be produced by a compiler, machine code, such as may be produced by an assembler or a linker, byte code, such as may be generated by for example by a JAVA™ compiler and may be executed using a JAVA™ virtual machine or equivalent, or files containing higher level code that may be executed by the computer using an interpreter (for example, scripts written in Python™, Perl™, Ruby™, Groovy™, or any other scripting language).

In some aspects, systems may be implemented on a standalone computing system. Referring now to FIG. 2b, there is a block diagram depicting a typical exemplary architecture of one or more aspects or components thereof on a standalone computing system. A computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the LINUX™ operating system, ANDROID™ operating system, or the like. In many cases, one or more shared services 23 may be operable in system 20, and may be useful for providing common services to client applications 24. Services 23 may, for example, be WINDOWS™ services, user-space common services in a LINUX™ environment or any other type of common service architecture used with an operating system 22. Input devices 28 may be of any type suitable for receiving user input including, for example, a keyboard, touchscreen, microphone (for example, for voice input), mouse, touchpad, trackball or any combination thereof. Output devices 27 may be of any type suitable for providing output to one or more users, whether remote or local to system 20, and may include, for example, one or more screens for visual output, speakers, printers or any combination thereof. Memory 25 may be RAM having any structure and architecture known in the art for use by processors 21, for example to run software. Storage devices 26 may be any magnetic, optical, mechanical, memristor or electrical storage device for storage of data in digital form (such as those described above, referring to FIG. 2a). Examples of storage devices 26 include flash memory, magnetic hard drive, CD-ROM, and the like.

In some aspects, systems may be implemented on a distributed computing network, such as one having any number of clients and/or servers. Referring now to FIG. 2c, there is a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 2b. In addition, any number of servers 32 may be provided for handling requests received from one or more clients 33. Clients 33 and servers 32 may communicate with one another via one or more electronic networks 31, which may be in various aspects any Internet, wide area network, mobile telephony network (such as CDMA or GSM cellular networks), wireless network (such as WiFi, WiMAX, LTE, and so forth) or local area network (or indeed any network topology known in the art; the aspect does not prefer any one network topology over another). Networks 31 may be implemented using any known network protocols, including, for example, wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored on a server system 32 in the Cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web system. It should be understood by one having ordinary skill in the art that any configuration or security subsystems known in the art now or in the future may be used in conjunction with aspects without limitation, unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to a computer system 40 without departing from the broader scope of the system and method disclosed herein. A CPU 41 is connected to bus 42, to which bus is also connected to memory 43, non-volatile memory 44, display 47, I/O unit 48, and network interface card (NIC) 53. An I/O unit 48 may, typically, be connected to peripherals such as a keyboard 49, pointing device 50, hard disk 52, real-time clock 51, camera 57, and other peripheral devices. A NIC 53 connects to a network 54, which may be the Internet or a local network, which local network may or may not have connections to the Internet. The system may be connected to other computing devices through the network via a router 55, wireless local area network 56 or any other network connection. Also shown as part of a system 40 is a power supply unit 45 connected, in this example, to a main alternating current (AC) supply 46. Not shown are batteries that could be present and many other devices and modifications that are well known, but are not applicable to, the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

FIG. 3 illustrates example embodiments of a web pages and application screens for a system and method for pushing recommended trades to a mobile device according to the present invention. FIG. 3 shows an Order Recommendation according to the present invention. Once a recommended order 101 is received by the one or more of the client's devices 111a-c and descripted by the mobile application 401 running on these devices, a mobile application screen 300 is presented to a client as shown in FIG. 3. The recommended order 101 may include one or more of the following data fields of information: broker info 301, client info 302, recommended trade information 303, current market information 304, recommended trade research URL web links 305a-c, and/or recommended trade research documents 306a-c. The mobile application screen 300 also may include an estimated total cost for the trade 315, and a confirm order button 310.

The broker info field 301 and client info field 302 may list identifying information regarding the broker who sent the order 101 and the client to which the order 101 was intended. This information may include name, address, phone and mobile numbers, email address and other similar contact information. These phone numbers and email addresses may include a hyperlink that directly permits the client to initiate communication with the broker if desired.

The recommended trade information 303 may include any and all useful information regarding the proposed trade. This data may include the ID 301a, account ID 301b, max and min price for any confirmed trade 303c-d, an expiration date and time for the order 303e, reference to after-market hours trading and other markets around the world to be used to complete the trade, a type of transaction 303f, the number of shares 303g, and the expected price 303h.

The current market information 304 may include information on the current state of the market, including various known market indexes, price and index value changes during one or more time periods, and any other information that the broker and client may use to evaluate the recommended trade order 101.

The recommended trade research URL web links 305a-c and recommended trade research documents 306a-c provide the broker a mechanism to share the due diligence research that is available for consideration by a client. This information may be presented to the client using a URL web link 305a-c that allows the client to review the information available over the Internet 110 using a web browser. This information also may be provided in the form of a document 306a-c in which the information is shared along with the order 101. These documents 306a-c are typically sent using a portable document format (PDF) from Adobe™ that may contain, text data, image data, and complex formatted documents. Other formats also may be utilized as needed.

The estimated cost 315 provides the client with an estimate for the cost of the trade as proposed. This estimated cost 315 may include any fees or other expenses to be incurred and may also use current market prices for the security being purchased if current market data is available to the mobile application 401.

The confirm button 310 triggers the mobile application 401 to generate a confirmation 102 for the order 101 and send it to the broker for execution. This confirm button 310 generates a message containing the order for the broker to purchase the, populates the confirmation message 102 with the data from the order 101, applies any client identification data and/or data encryption to provide an assurance that the authorized client is making the order to purchase the.

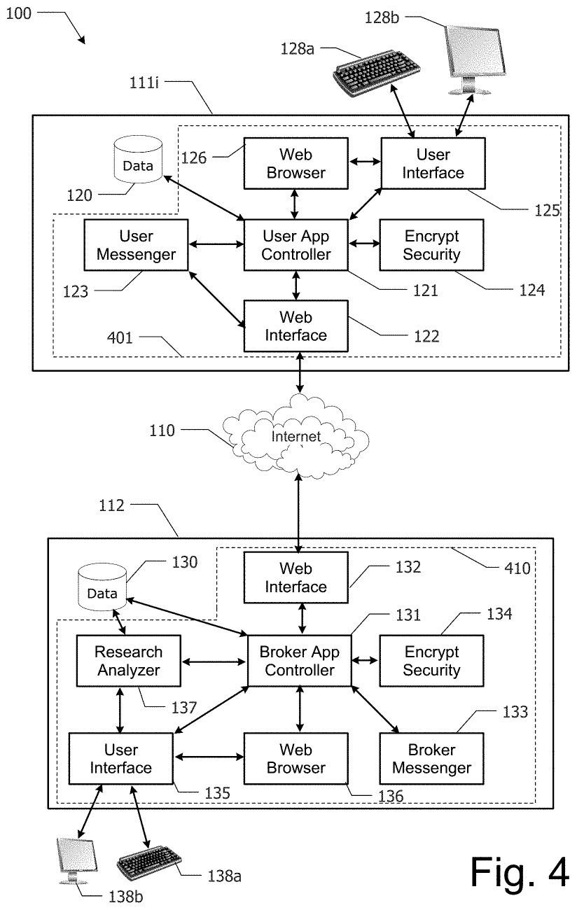

FIG. 4 illustrates a computing system of software components of a system for pushing recommended trades to a mobile device according to the present invention. FIG. 4 shows a client mobile application 401 running on one or more of the client processing systems 11a-c that communicates with the broker via a server application 410 running on a web server 115. As noted above in reference to FIG. 1, the broker computing system 112 may generate a send a recommended order 101 to a client mobile device 111a-c directly or via a web server. The embodiment of FIG. 4 illustrates the software components that are used to communicate with the client and process both the order 101 and confirmation 102. These software components 410 may be hosted on a web server 115, the broker computing system 112, and a combination of these systems. The functionality disclosed herein exists through the interaction of these systems.

The mobile application 401 utilizes a set of mobile application software components 121-126. This set of mobile application software components 121-126 includes a user application controller 121, a web interface 122, a user messenger 123, an encryption-security processor 124, a user interface 125, a web browser 126, and local data storage 120 for maintaining copies of the orders 101, confirmations 102, and research information 105a-c, 106a-c exchanged between the mobile devices 111a-c and the web server 115.

The user application controller 121 acts as a central overall controller for the set of broker application software components 121-126. User commands from the user interface 125 are received and processed to determine actions to be taken, and then mobile app commands are passed to the other software components 122-126, as needed, to implement the actions to be taken. The user application controller 121 also works with the encryption-security processor 124 to determine whether or not a particular user of the mobile application 401 at any particular point in time is authorized to access particular data entries within the orders and confirmations 102 and take particular actions that may be requested. The user application controller 121 is responsible for enforcing these security privileges

The web interface 122 permits the client mobile devices 111a-c to communicate with the remote broker computing devices 112 and the web server 115. The web interface 122 performs all of the data formatting, computer-to-computer communications, encryption processing, and all similar operations needed by the web server to communicate with other computing systems.

The user messenger 123 permits the mobile application 401 to communicate with remote computing systems such as the web server 115 and the broker computing system 112. The user messenger 123 may send orders 101 and confirmations 102 to other systems as needed. The user messenger 123 may communicate using email messages, SMS text messages, and similar electronic data exchange mechanisms. The user messenger 123 also may receive data from other computing systems for inclusion within the local data storage 120.

The encryption-security processor 124 is responsible for performing all security-related tasks associated with receiving orders 101 from brokers and generating and communicating any order confirmations 102 sent back from the web browser 115. The encryption-security processor 124 performs any data encryption and decryption to messages exchanged with the broker application 410. The broker encryption-security processor 124 manages any encryption keys, passwords, and other unique codes associated with a particular client. The encryption-security processor 124 also performs any user authentication operations including password verification, two-factor login matching, and biometric data comparisons performed by the client mobile devices 111a-c.

The user interface 125 provides input and output processing to provide a client with messages and data needed to perform the review of any incoming orders 101, identify research URLs 105a-c, and research documents 106a-c. All of this data is rendered in an appropriate format for display on a display device 128b. The user interface module 125 also accepts commands from the client generated on an attached input device 128a to instruct the client mobile application 401 to perform these tasks.

The user web browser 126 provides an integrated ability to communicate with remote web servers to obtain data and web pages as needed. The user web browser 126 is utilized to access research data identified in the identified research URLs 105a-c provided as part of the order 101. The user web browser 126 also may allow the client to access other web pages, including web search platforms such as Google™, Bing™, and DuckDuckGo™. The web browser 126 renders the web pages for viewing by the client on display devices 128b via the user interface 125.

The broker application 410 utilizes a set of broker application software components 131-137. This set of broker application software components 131-137 includes a broker application controller 131, a web interface 132, a broker messenger 133, a broker encryption-security processor 134, a user interface 135, a web browser 136, a research analyzer 137, and locate data storage 130 for maintaining copies of the orders 101, confirmations 102, and research information 105a-c, 106a-c exchanged between the mobile devices 111a-c and the web server 115.

The broker application controller 131 acts as a central overall controller for the set of broker application software components 131-137. User commands from the broker user interface 135 are received and processed to determine actions to be taken, and then mobile app commands are passed to the other software components 132-137, as needed, to implement the actions to be taken. The broker application controller 131 also works with the broker encryption-security processor 134 to determine whether or not a particular user of the mobile application 401 at any particular point in time is authorized to access particular data entries within the orders and confirmations 102 and take particular actions that may be requested. The broker application controller 131 is responsible for enforcing these security privileges.

The broker web interface 132 permits the web server 115 to communicate with remote user computing devices 111a-c. The web interface 132 performs all of the data formatting, computer-to-computer communications, encryption processing, and all similar operations needed by the web server 115 to communicate with users.

The broker messenger 133 permits the broker application 410 to communicate with remote client mobile devices 111a-c. The broker messenger 133 may send orders 101 and confirmations 102 to other systems as needed. The broker messenger 133 may communicate using email messages, SMS text messages, and similar electronic data exchange mechanisms. The broker messenger 133 also may receive data from other computing systems for inclusion within the local data storage 130.

The broker encryption-security processor 134 is responsible for performing all security related tasks associated with providing orders 101 to clients and confirming any order confirmations 102 received back from clients. The broker encryption-security processor 134 performs any data encryption and decryption to messages exchanged with the client mobile application 401. The broker encryption-security processor 134 manages any encryption keys, passwords, and other unique codes associated with a particular client. The broker encryption-security processor 134 also performs any user authentication operations including password verification, two-factor login matching, and biometric data comparisons performed by the web server 115.

The broker user interface 135 provides input and output processing to provide a broker with messages and data needed to perform the due diligence research with the research analyzer 137, review orders 101 to be sent to clients and confirmations received from clients, and web content via the broker web browser 136. This broker user interface module 135 also accepts commands from the broker's attached input device 138a to instruct the broker application 410 to perform these tasks. In embodiments in which the broker application 410 is mainly hosted on the web server 115, the broker user interface 135 and the broker web browser 136 are typically hosted on the broker computing system 112 that interacts with the remaining components 131-137 on the web server 115.

The broker web browser 136 provides an integrated ability to communicate with remote web servers to obtain data and web pages as needed. The broker web browser 136 is utilized to access research data identified in the identified research URLs 105a-c provided as part of the order 101. The broker web browser 136 works with the research analyzer 137 to perform due diligence research that forms a basis for the broker making recommendations to clients. The broker web browser 136 may also allow the broker to access other web pages, including web search platforms such as Google™, Bing™, and DuckDuckGo™. The broker web browser 136 renders the web pages for viewing by the client on display devices 138b via the user interface 135.

The research analyzer 137 provides a broker with access to research data regarding various s available for trading. The research analyzer 137 may access proprietary data sources available to the broker, on-line public data sources, and other web-based data that assists the broker in making recommendations. The research analyzer 137 also stores and provides the broker access to the identified research URLs 105a-c and research documents 106a-c that are part of the due diligence research. The research analyzer 137 may provide a storage mechanism to permit the broker to document all of the data sources consulted as part of a particular research task in order to document the efforts included within the due diligence research.

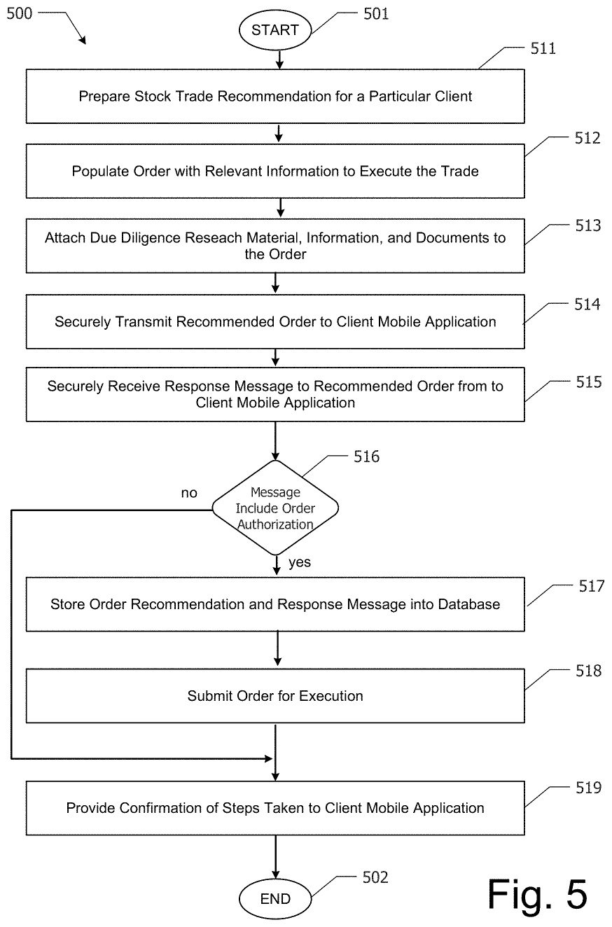

FIG. 5 illustrates a flowchart corresponding to a method performed by software components of a system for pushing recommended trades to a mobile device according to the present invention. The process 500 begins 501 and a trade recommendation is created within the broker computer 112 for a particular client based upon the client's identity, level of acceptable risk, relevant market sectors and the like in step 511. The recommended order is populated with current data values by the broker computer 112, including symbol, acceptable order price or condition, number of shares, and similar relevant information needed to define and place an order for a transaction in step 512.

Net in step 513, due diligence research material, information, and documents are attached to the recommended order. This information and material may be present as a URL web link to information available to the client using a web browser, may include text and other data recited by the broker, and may provide copies of documents for review. These documents may be in many formats, however in a preferred embodiment, these documents are provided as a Portable Document Format (PDF) from Adobe™ that is readily reviewable on most computing systems, mobile devices and the like.

The recommended order, in step 514 is securely transmitted to the client mobile application 111i shown in FIG. 4 above. This recommended order may be sent in an encrypted form as a message such as an email or an SMS text message. The message may contain data that may only be decrypted and read by the client using the mobile application 111i. In other embodiments, the message may include a URL web link to prevent the recommended order data file from being accessed by any party without being logged into and authenticated by the system 100. The client responds in step 515 to the recommended order with a secure response message sent by the mobile application 111i. The response will provide an indication of the client's instruction that may include a complete and executable order to cause a transaction to occur. The response may also include an indication that the client declines to act upon the recommended order. Because the recommended order is a form containing all of the information needed to define an order, the client may edit any of the values contained therein to define the requirements and terms of the order before returning it to the broker computer for execution. For example, the number of shares and a limit on a price to be paid for the are two examples of these values that the client may wish to modify before returning the order for execution.

The broker computer 112 determines whether the response message includes an executable order for a transaction in test step 516. When test step 516 determines that an executable order is present, the process 500 proceeds to step 517 to store a copy of the recommended order message and the client's response message into a transaction database for later retrieval when needed in response to an audit or client dispute. At the same time, the executable order is submitted to the appropriate system to execute the order as specified in the order returned from the client in step 518.

The broker computer 112 in step 519 provides notification of the execution of the returned order to the client with any relevant confirmation information such as price, order transaction number or the like. Once the confirmation has been acknowledged, the process 500 ends 502.

Returning to test step 516, when the test step 516 determines that the response from the client does not include an executable order, the process 500 proceeds to step 519 in order to provide confirmation to the client mobile application 111i that the response has been received and no action was taken before the process 500 ends 502.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise. Any singular term used in this present patent application is applicable to its plural form even if the singular form of any term is used.

In the present application, all or any part of the invention's software or application(s) or smart device application(s) may be installed on any of the user's or operator's smart device(s), any server(s) or computer system(s) or web application(s) required to allow communication and transfer of content(s) or data between any combination of the components.

1. A system for pushing recommended trades to a mobile device, the system commutatively couples a broker computer to a client mobile device over the Internet, the broker computer comprises:
a broker application controller;
a non-transitory memory storing a program; and
a web interface configured to establish communication connections with the one or more client devices and the one or more wireless extenders via the wireless network,
the broker application controller is configured to execute instructions stored within the non-transitory causing the broker application controller to:
create a recommendation order for submission to a client for approval;
populate the recommendation with data values to define a transaction being recommended;
attach due diligence research information to the recommended order for providing relevant information to the client;
securely transmit the recommended order to a client mobile application running on the client mobile device, the recommended order comprises a link to submit a responsive client response message upon activation by the client;
securely receive the responsive client responsive message from the client mobile application running on the client mobile device providing an acceptance of the recommended order, the responsive message contains a completed order for a transaction;
execute the completed order; and
transmit confirmation of an executed transaction based upon the completed order to the client mobile application running on the client mobile device.

2. The system according to claim 1, wherein the due diligence comprises text and graphical information, hyperlinks to web pages containing relevant information, and research documents related to the recommended order for review using the client mobile application.

3. The system according to claim 1, wherein the recommendation order comprises number of shares, one or more price limits, and one or more time periods to be used in defining the transaction contained within the recommended order.

4. The system according to claim 1, wherein the completed order contains modified data values defining the transactions from the corresponding data values in the recommended order.

5. The system according to claim 4, wherein the modified data values comprise changes to one or more data values made in the client mobile application defining the transactions contained in the recommended order.

6. The system according to claim 1, wherein the broker application controller is further configured to cause the broker application controller to:
receive a responsive message to the recommended order rejecting the recommendation; and
provide confirmation to the client mobile application running on the client mobile device that no further action will be taken.

7. A method for pushing recommended trades to a mobile device, the method comprises:
creating a recommendation order for submission to a client for approval;
populating the recommendation with data values to define a transaction being recommended;
attaching due diligence research information to the recommended order for providing relevant information to the client;
securely transmitting the recommended order to a client mobile application running on the client mobile device, the recommended order comprises a link to submit a responsive client response message upon activation by the client;
securely receiving the responsive client responsive message from the client mobile application running on the client mobile device providing an acceptance of the recommended order, the responsive message contains a completed order for a transaction;
executing the completed order; and
transmitting confirmation of an executed transaction based upon the completed order to the client mobile application running on the client mobile device.

8. The method according to claim 7, wherein the due diligence comprises text and graphical information, hyperlinks to web pages containing relevant information, and research documents related to the recommended order for review using the client mobile application.

9. The method according to claim 7, wherein the recommendation order comprises number of shares, one or more price limits, and one or more time periods to be used in defining the transaction contained within the recommended order.

10. The method according to claim 7, wherein the completed order contains modified data values defining the transactions from the corresponding data values in the recommended order.

11. The method according to claim 10, wherein the modified data values comprise changes to one or more data values made in the client mobile application defining the transactions contained in the recommended order.

12. The method according to claim 7, wherein the method further:
receives a responsive message to the recommended order rejecting the recommendation; and
provides confirmation to the client mobile application running on the client mobile device that no further action will be taken.

13. A non-transitory computer-readable recording medium in a broker computer for pushing recommended trades to a mobile device, the broker computer configured to communicatively interconnect one or more client mobile devices over the Internet, the non-transitory computer-readable recording medium storing one or more programs which when executed by a broker application controller of the broker computer performs steps comprising:
creating a recommendation order for submission to a client for approval;
populating the recommendation with data values to define a transaction being recommended;
attaching due diligence research information to the recommended order for providing relevant information to the client;
securely transmitting the recommended order to a client mobile application running on the client mobile device, the recommended order comprises a link to submit a responsive client response message upon activation by the client;
securely receiving the responsive client responsive message from the client mobile application running on the client mobile device providing an acceptance of the recommended order, the responsive message contains a completed order for a transaction;
executing the completed order; and
transmitting confirmation of an executed transaction based upon the completed order to the client mobile application running on the client mobile device.

14. The non-transitory computer-readable recording medium according to claim 13, wherein the due diligence comprises text and graphical information, hyperlinks to web pages containing relevant information, and research documents related to the recommended order for review using the client mobile application.

15. The non-transitory computer-readable recording medium according to claim 13, wherein the recommendation order comprises number of shares, one or more price limits, and one or more time periods to be used in defining the transaction contained within the recommended order.

16. The non-transitory computer-readable recording medium according to claim 13, wherein the completed order contains modified data values defining the transactions from the corresponding data values in the recommended order.

17. The non-transitory computer-readable recording medium according to claim 16, wherein the modified data values comprise changes to one or more data values made in the client mobile application defining the transactions contained in the recommended order.

18. The non-transitory computer-readable recording medium according to claim 13, wherein the broker application controller is further configured to cause the broker application controller to:
receive a responsive message to the recommended order rejecting the recommendation; and
provide confirmation to the client mobile application running on the client mobile device that no further action will be taken.
